(19) United States
(12) Patent Application Publication
(10) Pub. No.: US 2005/0100725 A1
(43) Pub. Date: May 12, 2005

(54) Porous sheet made of fluorine-containing polymer and method of producing liquid crystal display panel with using the same

(75) Inventors: Tetsuo Shimizu, Settsu-shi (JP); Katsusada Tokuhira, Settsu-shi (JP); Hitoshi Imamura, Settsu-shi (JP); Takahisa Sakamoto, Settsu-shi (JP)

Correspondence Address: SUGHRUE MION, PLLC, 2100 PENNSYLVANIA AVENUE, N.W., SUITE 800, WASHINGTON, DC, 20037, US

(73) Assignee: DAIKIN INDUSTRIES, LTD.

(21) Appl. No.: 11/004,980

(22) Filed: Dec. 7, 2004

Related U.S. Application Data
(62) Division of application No. 10/332,508, filed on Jan. 10, 2003.

(30) Foreign Application Priority Data
Jul. 12, 2000 (JP) P2000-211223

(51) Int. Cl. G02F 1/1339; B32B 3/26; C09J 5/10; B32B 7/12

(52) U.S. Cl. 428/304.4; 156/306.9; 428/317.1

(57) ABSTRACT

A method of producing a liquid crystal display panel, which comprises compressing at least one liquid crystal cell to squeeze spacers so as to prepare a space for enclosing uniformly a liquid crystal, and then using a cushioning material made of a fluoropolymer on at least one main surface of the liquid crystal cell in a step of curing a laminating resin and/or a step of curing a resin for sealing a liquid crystal enclosure inlet after at least one liquid crystal cell enclosing the liquid crystal is pressed to discharge excess liquid crystal, is disclosed. This method improves the yield of the liquid crystal display panel.

### CROSS REFERENCE TO RELATED APPLICATIONS

This is a Divisional of application Ser. No. 10/332,508 filed Jan. 10, 2003, which is a 371 of PCT Application No. PCT/JP01/05608 filed Jun. 29, 2001, incorporated herein by reference.

### FIELD OF THE INVENTION

The present invention relates to a cushioning material comprising a porous sheet made of fluorine-containing polymer, and a method of producing liquid crystal display panel with using the same and a porous polytetrafluoroethylene sheet suitable for said cushioning material.

### RELATED ARTS

A liquid crystal display panel comprises a liquid crystal cell formed by superposing two glass substrates. The liquid crystal cell has fine lattices, which as whole are referred to as “liquid crystal cell”. A liquid crystal is filled into the vacant liquid crystal cell and an inlet of the liquid crystal cell is sealed to give a resultant product which is referred to as “liquid crystal display panel”. The liquid crystal display panel is provided with a gate electrode, a driver LSI, a control IC and the like to give a liquid crystal module. The liquid crystal module finally provided with a display function is referred as “liquid crystal display device”.

The liquid crystal cell prepared by superposing two glass substrates constituting the liquid crystal display panel can be prepared, for example, through a step of forming a liquid crystal element comprising a thin film transistor, wires connecting with said thin film transistor, and pixel electrodes on the glass substrate; a step of overlaying the glass substrates each other; and a step of attaching a polarization plate to a surface of the glass substrate. The liquid crystal display device is formed by filling the liquid crystal cell with the liquid crystal and connecting the driver IC to the liquid crystal cell. The step of laminating the glass substrates producing the liquid crystal cell has, for the purpose of cost decrease, a stage of stacking and simultaneously compressing a large number of liquid crystal cells.

However, when the liquid crystal cells are stacked and compressed, the liquid crystal cells have troubles that, for example, the glass substrate is damaged with a foreign substance, the cells are not uniformly compressed and the glass substrate is broken, thus causing the decrease of the yield of resultant liquid crystal cells.

### SUMMARY OF THE INVENTION

One object of the present invention is to provide a method to producing a liquid crystal display panel, which method has the improved yield of liquid crystal cells.

Another object of the present invention is to provide a cushioning sheet made of a fluoropolymer which improves the yield of liquid crystal cells.

Further object of the present invention is to provide porous polytetrafluoroethylene sheet excellent in repeated usability.

The present inventors discovered that, when a cushioning material made of a fluoropolymer having the properties such as heat resistance, thermal insulation property, non-tackiness and cushioning property, particularly polytetrafluoroethylene (PTFE) is used in a process of producing a liquid crystal display panel, the steps and the yield are improved.

According to one aspect, the present invention provides a method of producing a liquid crystal display panel, which comprises pressing at least one liquid crystal cell prepared by overlaying two glass substrates each other to squeeze spacers so as to prepare a space for enclosing uniformly a liquid crystal, and then using a cushioning material consisting of a porous fluoropolymer sheet on at least one main surface of the liquid crystal cell in a step of curing a laminating resin and/or a step of curing a resin for sealing a liquid crystal enclosure inlet after at least one liquid crystal cell enclosing the liquid crystal is pressed to discharge an excess liquid crystal.

According to another aspect, the present invention provides a porous fluoropolymer sheet for production of a liquid crystal display panel which is used as a cushioning material in a step of curing a laminating resin and/or a step of curing a resin for sealing a liquid crystal enclosure inlet after at least one liquid crystal cell enclosing the liquid crystal is pressed to discharge an excess liquid crystal, which steps are after pressing at least one liquid crystal cell to squeeze spacers so as to prepare a space for enclosing uniformly a liquid crystal.

According to further aspect, the present invention provides a porous polytetrafluoroethylene sheet prepared by dispersing a fibrous polytetrafluoroethylene powder having an average fiber length of 100 μm to 5,000 μm in a liquid and straining the dispersion to give the sheet, wherein the sheet has the void ratio of 20% to 55%.

### DETAILED DESCRIPRION OF THE INVENTION

In the present invention, the sheet is used in the step of laminating the liquid crystal cells and in the step of enclosing the liquid crystal and sealing the inlet, to give the liquid crystal display panel comprising the liquid crystal cell. That is, strictly speaking, the present invention relates to a step of producing the liquid crystal cell and to a step of producing the liquid crystal display panel. Since the liquid crystal cell production step is one step in the liquid crystal display panel production, the production method of the present invention is referred to as the method of producing the liquid crystal display panel.

Two glass substrate are overlaid each other under the state that the spacers made of, for example, plastic beads are sandwiched between the glass substrates to form a space for containing the liquid crystal between the glass substrates. A sealing material is previously coated between the glass substrates so as to laminate the glass substrates. After the glass substrates are overlaid each other, the sealing material is cured while compressing the glass substrates. Thermally curable and ultraviolet curable sealing materials are generally known as the sealing material. During the compression for the lamination, the fluoropolymer sheet of the present invention is used.

Additionally, the liquid crystal cell is compressed in the step of curing the resin for sealing the liquid crystal enclosure inlet, after the above lamination step is conducted, the liquid crystal is enclosed in the resultant liquid crystal cell, and then the liquid crystal cell is pressed so as to discharge an excess liquid crystal. The fluoropolymer sheet of the present invention is used also during this compression for curing the resin.

Hereinafter, (1) the step of the lamination, (2) the step of charging the liquid crystal and (3) the step of sealing, which are used in the method of producing the liquid crystal display panel, are explained. In the present invention, the cushioning sheet made of fluoropolymer is used both in the step of laminating the glass substrates after coating the spacers and in the step of compression after charging the liquid crystal (that is, the step of sealing).

(1) Step of Lamination

An orientation film material is coated on the glass substrates and is rubbed, and a resin for lamination (that is, a sealing material) is coated by a dispenser in the thickness of 20 μm to 50 μm, for example, 30 μm on periphery of the glass substrate. One or several gaps having a length of 10 mm to 20 mm are formed for charging the liquid crystal after the lamination. After the step of connecting with a color filter, spacers in the form of particles having the diameter of 20 μm to 50 μm, for example, 30 μm are uniformly distributed to give the space for enclosing the liquid crystal. The spacers may be pillar spacers provided on the color filter. Tendency replacing the particle-type spacers by the pillar spacers of color filter are active, and the fluoropolymer cushioning sheet is effective also in the lamination step using such color filter having the pillar spacers.

Then TFT electrodes, glass substrates and the like are overlaid while locating by a camera. Several dozen of the thus prepared liquid cells are stacked, heated while compressed to squeeze the spacers from the size of 20 μm to 50 μm to the size of about 2 μm to 10 μm, particularly about 5 μm. Usually, the spacers are heated to the temperature of 150° C. to 200° C. for 5 hours to 10 hours while compressed under the load of 0.02 MPa to 0.4 MPa (0.2 kg/cm² to 4.0 kg/cm²) to cure the sealing material such as an epoxy resin.

During the compression, the fluoropolymer cushioning sheet is positioned between the glass substrate and a compressing machine, and/or the fluoropolymer cushioning sheet is positioned between the glass substrates to be laminated. Thus, even if a foreign substance is present, it is embedded in the fluoropolymer sheet so that a damage of the glass substrate is prevented and the pressure is uniformly applied.

The cushioning sheet is a porous material made of fluoropolymer which has the heat resistance and the heat insulation property so that the breakage of glass caused by heat is prevented and the yield is increased. When the liquid crystal cells are peeled off each other after molding, the workability is good because of good demoldability caused by non-tackiness of the fluoropolymer.

Then, the step of charging the liquid crystal into the liquid crystal cell is performed.

(2) Step of Charging Liquid Crystal

After the resin for lamination, such as the epoxy resin is cured, the liquid crystal cell is removed, the inner atmosphere of the liquid crystal is vacuumed in a vacuum chamber, and then the liquid crystal is drawn into the cell.

(3) Step of Sealing

When some number of liquid crystal cells are stacked and pressed, the fluoropolymer cushioning sheet is sandwiched between the liquid crystal cells, the pressure, for example, of 1,000 Pa (about 1 kg/15 inch²) is applied, and an excess liquid crystal is discharged and wiped off. Then the sealing material is coated and cured by an ultraviolet lamp. A polarizing plate is attached to complete the liquid crystal cell.

The thickness of the porous fluoropolymer sheet used in the steps (1) and (3) may be from 0.2 mm to 2.0 mm, preferably from 0.3 mm to 1.5 mm, more preferably from 0.5 mm to 1.0 mm. The void ratio of the porous fluoropolymer sheet may be from 20% to 80%, particularly from 20% to 55%.

The porous fluoropolymer sheet is preferably made of polytetrafluoroethylene. The fluoropolymer cushioning sheet may be made of a copolymer consisting of tetrafluoroethylene and at most 1% by weight, based on the copolymer, of another comonomer. Examples of the another comonomer include hexafluoropropylene, perfluoro(methylvinylether), perfluoro(propylvinylether), perfluoro(isopropylvinylether) and chlorotrifluoroethylene.

As the polytetrafluoroethylene sheet, PA-5L and PA-10L which are a fluororesin sheet product manufactured by Daikin Industries Co., Ltd. can be used. The fluoropolymer sheet can be prepared by methods described in, for example, JP-B-42-5244 and US-A-3003912. Specifically, a paper-like product can be prepared by charging, into water or water containing a surfactant, a fibrous polytetrafluoroethylene powder having an average fiber length of 100 to 5,000 μm and an average form factor of at least 10 (The “average form factor” means a coefficient resulting by dividing an arithmetic mean of length in fiber direction of the powder, by an arithmetic mean of a fiber width, arbitrarily observed by a microscope), or a fibrous polytetrafluoroethylene powder obtained by extruding colloidal particles of polytetrafluoroethylene containing an extrusion aid from a thin nozzle, cutting the resultant rod or tube into pieces having the length of 6 mm to 25 mm and applying a friction force, to give a dispersion; and straining the dispersion.

Since the fluoropolymer sheet can be used in the step of lamination of the glass substrates and in the step of sealing within the method of producing the liquid crystal display panel, the fluoropolymer sheet is subjected to 150° C. to 200° C. for 5 hours to 10 hours, depending on the type of the sealing material. At this time, a problem that a fluoropolymer sheet is shrunk may occur. The fluoropolymer sheet which is mass-produced by a continuous paper manufacturing has a difference of shrinkage between a drawing direction and a vertical direction, and the shrinkage is large in the drawing direction. The reason therefor is believed that in the baking step at 300° C. to 400° C., which is performed after drying step at 100° C. following the web production, the baking is insufficient, since a residence time is usually several minutes in the continuous paper manufacturing.

The porous polytetrafluoroethylene sheet is preferably thermally treated so that the sheet has a maximum shrinkage ratio of at most 5% upon the thermal treatment of 200° C. for 1 hour. Such a sheet can be prepared by thermally treating a paper, which is obtained by straining a dispersion, at 150° C. to 320° C., preferably at 180° C. to 220° C.

The porous polytetrafluoroethylene sheet preferably has a thickness retention ratio of at least 85% when the sheet is treated at the temperature of 180° C. and the load of 0.06 MPa (0.6 kg/cm²) for 360 hours.

### PREFERRED EMBODIMENTS OF THE INVENTION

The following Examples and Comparative Examples are shown, which illustrate the present invention.

In the following Examples, properties of a sheet were measured as follows:

Void ratio
Void ratio (%)=[(Specific gravity of resin)−d]×100/(Specific gravity of resin)

(Specific gravity of resin is 2.2 in the case of PTFE)
Specific gravity, d(g/cm³)=weight (g)/[area (cm²)×thickness (cm)]
Tensile strength

A test piece having the width of 15 mm was examined at a distance between chucks of 30 mm and a tensile speed of 30 mm/min.

Flexibility

The flexibility was evaluated according to the following criteria by sandwiching a sheet between a thumb and an index finger.

A: Easily bendable and having the same flexibility as buckskin.

C: Similar to felt.

B: Intermediate between A and C.

Thickness Retention Ratio

The thickness retention ratio [(L/L₀×100) (%)] was calculated from a thickness L of a sheet after left standing at 180° C. and the load of 0.06 MPa (0.6 kg/cm²) for 360 hours and a thickness L₀ of an unused sheet.

Repeated Usability

The repeated usability was evaluated by performing a heat and pressurization test which repeats 72 cycles of the procedure of retaining a sheet under the conditions of the temperature of 180° C. and the load of 0.06 MPa (0.6 kg/cm²) for 5 hour. Larger the thickness retention rate is, more times the sheet can be repeatedly used. If the thickness is decreased and the flexibility is deteriorated, the performance as a cushioning material is decreased.

A: Flexibility is at least B and thickness retention ratio is at least 80% after heat and pressurization test.

B: Flexibility is at least B and thickness retention ratio is at least 65% and less 80% after heat and pressurization test.

C: Flexibility is C after heat and pressurization test.

### EXAMPLE 1

300 mL of trichlorotrifluoroethane was added to 3 g of a fibrous polytetrafluoroethylene powder having an average fiber length of 850 μm and an average form factor of 30, and the mixture was transferred to a 500 mL jar and sufficiently shaken to give a dispersion having no block of powder. Separately, 500 mL of trichlorotrifluoroethane was charged into a petri dish having a diameter of about 21 cm, and a 100-mesh stainless steel sieve having a diameter of 140 mm was submerged in the dish. Trichlorotrifluoroethane in the petri dish was used in the amount only immersing a screen of the sieve. When the above-mentioned previously prepared dispersion was transferred into the sieve, the powder was uniformly spread on the screen of the sieve. After several minutes, the sieve was slowly pulled up and dried. The resultant polymer sheet was rolled twice between the rolls having the temperature of 100° C. and the clearance of 0.2 mm. The sheet was baked in an electrical oven adjusted to the temperature of 340° C. for 40 minutes to give a thin flexible breathable fluoropolymer sheet.

### EXAMPLES 2 to 6

The procedure as in Example 1 was repeated, except that the fibrous polytetrafluoroethylene powder was used in the amount shown in Table 1 and the clearance between rolls was set to give the sheet having objective thickness, to produce the fluoropolymer sheet. The properties of the resultant fluoropolymer sheet are shown in Table 1.

TABLE 1
Properties of fluoropolymer sheet

| | Example No. | | | | | |
|---|---|---|---|---|---|---|
| | 1 | 2 | 3 | 4 | 5 | 6 |
| Fibrous powder | 1.5 | 8.0 | 4.0 | 6.0 | 8.0 | 12 |
| amount (g) | | | | | | |
| Thickness (mm) | 0.20 | 0.50 | 0.53 | 0.70 | 1.0 | 1.5 |
| Void ratio | 78 | 35 | 79 | 77 | 75 | 76 |
| (vol %) | | | | | | |
| Tensile | 1.3 | 1.8 | 1.3 | 1.4 | 1.4 | 1.4 |
| strength (MPa) | | | | | | |
| Unit area | 91 | 500 | 240 | 360 | 500 | 750 |
| weight (g/m²) | | | | | | |
| Flexibility | C | B | B | B | B | A |
| Thickness | — | 90 | 67 | 75 | 82 | — |
| retention ratio | | | | | | |
| Repeated | C | A | B | B | A | A |
| usability | | | | | | |

### EXAMPLES 7 AND 8

The size retention ratio (%) of the fluoropolymer sheet in environment in which the fluoropolymer sheet is used was measured. In Example 7, POLYFLON PAPER PA-5L manufactured by Daikin Industries Co., Ltd. was used as such. In Example 8, POLYFLON PAPER PA-5L was thermally treated at 200° C. for 5 hours. These sheets were left to stand at 180° C. under the load of 0.6 kg/cm² for 455 hours and a shrinkage ratio of the sheet was measured.

TABLE 2
Shrinkage ratio of fluoropolymer sheet

| | Example 7 | Example 8 |
|---|---|---|
| Drawing direction (%) | 96.6 | 99.6 |
| Direction perpendicular to | 99.4 | 99.9 |
| drawing (%) | | |

### EFFECT OF THE INVENTION

According to the present invention, the yield of the liquid crystal display panel is improved. The fluoropolymer sheet of the present invention can be repeatedly used in a large number of times in the production of the liquid crystal display panel. When the fluoropolymer sheet of the present invention is used, a large number of liquid crystal display panels can be simultaneously processed.

1. A method of producing a liquid crystal display panel, which comprises pressing at least one liquid crystal cell prepared by overlying two glass substrates each other to squeeze spacers so as to prepare a space for enclosing uniformly a liquid crystal display, and then using a cushioning material consisting of a porous fluoropolymer sheet on at least one main surface of the liquid crystal cell in a step of curing a laminating resin and/or a step of curing a resin for sealing a liquid crystal enclosure inlet after at least one liquid crystal cell enclosing the liquid crystal is pressed to discharge an excess liquid crystal.

2. The method according to claim 1, wherein the thickness of the porous fluoropolymer sheet is from 0.2 mm to 2.0 mm.

3. The method according to claim 1, wherein the void ratio of the porous fluoropolymer sheet is from 20% to 80%.

4. The method according to claim 1, wherein the porous fluoropolymer sheet is a porous polytetrafluoroethylene sheet.

5. The method according to claim 4, wherein the porous polytetrafluoroethylene sheet is prepared by dispersing a fibrous polytetrafluoroethylene powder having an average fiber length of 100 μm to 5,000 μm in a liquid to give a dispersion, and straining the dispersion.

6. The method according to claim 4, wherein the porous polytetrafluoroethylene sheet is thermally treated so that the sheet has a maximum shrinkage ratio of at most 5% upon the thermal treatment of 200° C. for 1 hour.

7. (canceled)

8. (canceled)

9. (canceled)

10. (canceled)

11. (canceled)

12. (canceled)

13. (canceled)

14. (canceled)

15. (canceled)

16. (canceled)
